(19) United States
(12) Patent Application Publication
(10) Pub. No.: US 2011/0257846 A1
(43) Pub. Date: Oct. 20, 2011

(54) WHEEL WATCHER

(76) Inventor: William Bennett, East Sandwich, MA (US)

(21) Appl. No.: 13/106,263

(22) Filed: May 12, 2011

Related U.S. Application Data
(63) Continuation-in-part of application No. 12/779,697, filed on May 13, 2010.
Application No. 12/779,697 is a continuation-in-part of application No. 12/618,495, filed on Nov. 13, 2009.

(51) Int. Cl. G06F 17/00

(52) U.S. Cl. 701/45

(57) ABSTRACT

A vehicle driver safety device that encourages drivers to drive attentively and with both hands on the steering wheel is disclosed.

### RELATED APPLICATIONS

This application claims the benefit of priority to U.S. utility application Ser. No. 12/779,697 filed on May 13, 2010, which itself claims priority to U.S. utility application Ser. No. 12/618,495 filed on Nov. 13, 2009, both of which are specifically incorporated herein by reference in its entirety.

### BACKGROUND

Distracted drivers are increasingly responsible for accidents on the roadways. In fact, the the number one cause of teen death in the United States today is injuries sustained through car crashes. It is probably no coincidence that teens these days are also texting while driving.

A system for encouraging safe and alert driving, particularly for teens or other distracted drivers, is needed.

### SUMMARY

The present invention features a driver safety system, which encourages drivers to maintain both hands on the steering wheel. In one embodiment, the system features: (a) a control system; (b) an alarm, which is connected to the control system and can transmit an audible signal to a driver; (c) a vehicle speed detector, which is connected to the control system; (d) a steering wheel cover, further comprising a plurality of sensors, which are connected in parallel to the control system and can detect when a driver removes his or her hand from the steering wheel; and (e) a timer, which is also connected to the control system and is triggered when a driver's hand is removed from the steering wheel cover, wherein the alarm can only be activated when the automobile is traveling above a pre-determined speed and at least one hand of the driver has not been in contact with the steering wheel cover for a pre-determined period of time.

The instant invention, which can be employed on steering wheels for a variety of vehicles, including, but not limited to a car, bus, truck, trolley or other vessel, encourages new drivers to drive with both hands on the steering wheel. By only turning on after a specified period of time and at a specified speed, the system allows the driver the opportunity to make adjustments (e.g. turn on the radio or sip coffee) without triggering the alarm. The instant invention may be particularly useful for new drivers, as it encourages them to drive with two hands on the wheel at all times.

Other features and advantages will become apparent based on the following specification and claims.

### BRIEF DESCRIPTION OF THE DRAWINGS

FIG. 1 is a frontal view of one embodiment of the present invention.

FIG. 2 is a diagram of the system controller.

FIG. 3 is a diagram of the controller input, control functions and controller actions or outputs.

FIG. 4a is a table of hand positions considered safe as a function of controller inputs.

FIG. 4b is a table of controller outputs as a function of drivers being absent from the steering wheel segments considered safe.

FIG. 5 is a frontal view of an embodiment of the present invention.

### DETAILED DESCRIPTION

Referring now to the drawings wherein like numerals designate like parts throughout the various views.

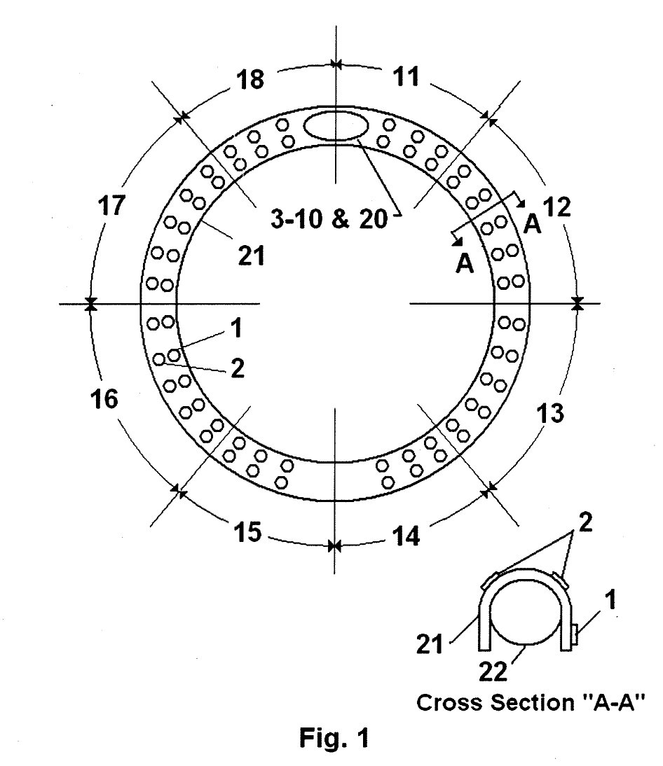

FIG. 1 shows an embodiment of the invention, which may be packaged and sold as an after-market accessory for installation on the steering wheel of a vehicle. Alternatively the components may be engineered into the steering wheel. Prior to installation, the accessory 21 has the outer appearance of a bicycle tire with a “U” shaped radial cross section (See cross section “A-A”). The accessory 21 can be made of a pliable material, which slips over the outer periphery of a steering wheel 22. The accessory 21 may be mounted in a way that prevents its removal from the steering wheel. For example, fasteners, such as zip ties may be located at one or more positions to further secure the accessory 21 to the steering wheel.

After the accessory 21 is mounted, simple electrical connections can be made to a vehicle power source (un-shown), headlights (un-shown) and/or horn (un-shown). Alternatively, the accessory may be self powered. For example, the accessory may be powered through a wireless power link, vibration or solar powered. Steering wheel indicators 1 which could be LEDs or any equivalent lighting device, may be incorporated into the accessory 21 to illuminate the steering wheel.

Steering wheel sensors 2 may detect the presence of a drivers hand (un-shown). The cross section “A-A” shows two steering wheel sensors 2, which become connected through the conductivity of the drivers hand to complete a circuit. In an alternative embodiment, conductive gloves are used to operate the steering wheel sensors. A variety of other sensor means than those, which detect a change in resistance, may be used to detect the presence or absence of one or both of the driver's hands on a steering wheel. For example, appropriate sensor means include a pressure type tactile switch (e.g. an electrical membrane switch), pneumatic, hydraulic or a combination of any of the above. Steering wheel sensor means in individual sectors may be connected in parallel to a system controller 20.

In one embodiment, the steering wheel cover has sensors 2 located on at least one sector 11-18 on each side of the center line of the accessory 21. However, for purposes o f this example, the accessory 21 has four sectors 11-14 and 15-18 on either side of the center line of the accessory 21. The remainder of the system components can also be located on the steering wheel or in a small compartment, located, for example, at the top center of the accessory 21 or on or under the dashboard.

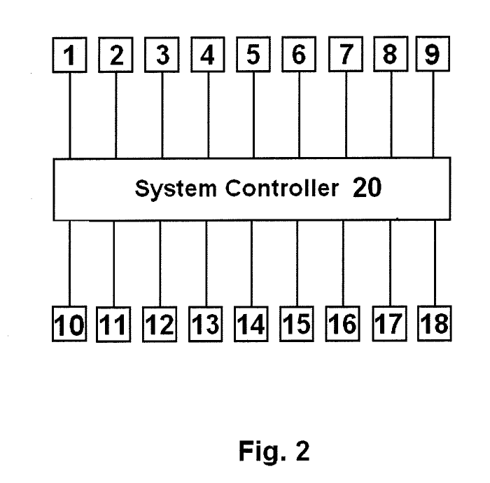

FIG. 2 is a diagram of one embodiment of the accessory 21. The system components include a driver ID device 3 which can be a simple keypad, card reader or RFID device containing a password that identifies the driver. A vehicle speed determining device 4 can be a Global Positioning System (GPS) or any other device that measures or otherwise determines the vehicle's speed. A clock/timer 5 can be positioned for ease of the driver reading the time without taking his eyes from the road. The timer feature of the clock/timer 5 can measure time elapsed from when a driver removes a hand from the steering wheel. A road condition determining device 6 can be a wireless device that correlates GPS position of the vehicle with an indication of the weather and reports the results wirelessly to the vehicle but could also be as simple as an air temperature thermometer (un-shown) and precipitation sensor (un-shown) in the vehicle. The recorder 7 can keep a record of the unsafe driving incidents by a driver for example, for review by a parent, rental agent or mentor of the driver. The recorder 7 can be a magnetic card, flash memory or wireless Internet connection. An internal alarm 8 can, for example, be an audible or visible indicator to the driver that an unsafe driving practice is in progress. An external alarm 9 could be a separate light or sound making device outside of the car to let drivers of nearby vehicles or the authorities know that the driver has been operating with at least one hand not in contact with the steering wheel for at least a specified period of time. The steering wheel cover can also include a driver comfort apparatus 10, for example comprising a vibrator or warmer for the comfort of the drivers hands especially on long trips. The driver comfort apparatus could be placed under system control based on the duration of a trip or may be manually activated by the driver. Other components 11-18 may also be incorporated.

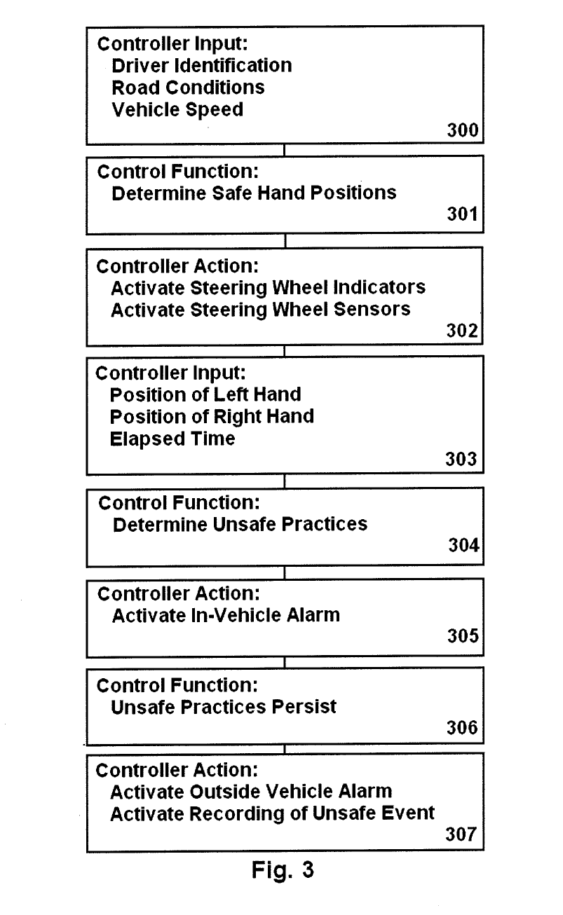

FIG. 3 shows a diagram of the functioning of the system controller means 20. The system controller means 20 can receive inputs identifying the driver, condition of the road and vehicle speed at step 300. From the three inputs at step 300 the controller 20 determines the hand positions of the driver assuring safe operation of the vehicle at step 301. At step 302 the controller activates the steering wheel indicators 1 that tell the driver where the best hand positions are located for safe driving practices and activates input from the corresponding steering wheel sensors 2. The controller 20 then looks for input from the left hand steering wheel sensors 2 at sectors 15-18 and the right hand steering wheel sensors 2 at sectors 11-14 as well as the clock/timer 5 to determine elapsed time at step 303. At step 304 the controller 20 determines that at least one hand of the driver is not in contact with the wheel. The timer 5 can then be started and after a pre-determined period of time passes (e.g., 3, 4, 5, 6, 7, 8, 9, 10 seconds or more), the in-vehicle alarm 8 can be activated at step 305. The timer may count down or count up to the predetermined period of time. Should the hand be disengaged from the wheel for a second pre-set period at step 306, the controller can activate the external vehicle alarm 9 in the form of flashing headlights or blowing of the horn at step 307.

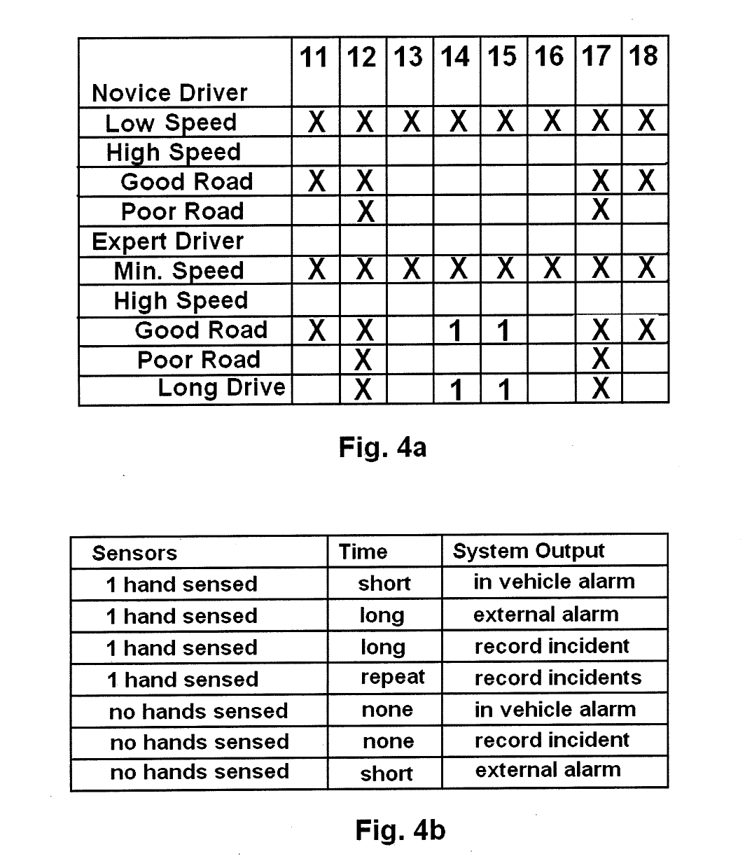

FIG. 4a is a table showing a preferred set of criteria that the system controller 20 may use to determine which steering wheel indicators 1 and steering wheel sensors 2 to activate. The table is broken into two major sections marked Novice Driver and Expert Driver. For both experts and novices, all of the sensors 1 and/or indicators 2 may be activated when the vehicle is moving at or below a pre-determined speed. However, the range of hand positions that may be activated can be increased or reduced at a pre-determined speed (e.g. 0.5 to 500 mph, including for example, 10, 20, 25, 30, 25, 30, 35, 40, 50, 55, 60, 65, 70 or 75 mph) and increased or decreased further depending on good or poor road conditions. The same is true for the expert driver, except that the expert driver may be given more leeway to rest one hand in sectors 14 or 15 on a good road or during a long drive.

FIG. 4b is a table of the system controller's 20 response to unsafe driving practices indicated by exceptions to keeping the drivers hands in the indicated steering wheel sectors 11-18. The first line of the table shows that if only one hand is sensed for a short time that the driver will be alerted by an in car alarm. If only one hand is sensed by the activated steering wheel sensor 2 an external alarm which could include flashing the headlights or blowing the horn externally to warn nearby drivers or authorities of unsafe driving practices. A recorder 7 may also be included, so that a driver's parent or mentor can be made aware that the driver is not keeping both hands on the wheel resulting in external alarms. The absence of both hands from the steering wheel 1 for a predetermined period of time, while the vehicle is moving may result in immediate activation of the internal alarm 8, external alarm 9 and/or recorder 7.

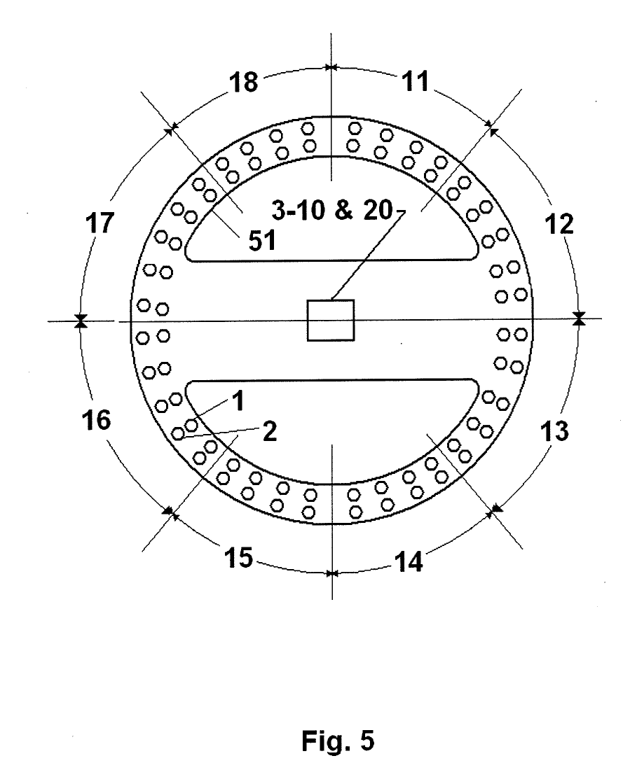

Another embodiment of the present invention, which is a modification of the embodiment shown in FIG. 1, is shown in FIG. 5 with like features numbered identically. This embodiment could be manufactured into the steering wheel at the factory. The primary difference is that the system controller and system components would be located in a larger cavity in the steering wheel hub. The operation of the system shown in FIGS. 2-4. is identical for this embodiment.

Those skilled in the art will recognize, or be able to ascertain using no more than routine experimentation, many equivalents to the specific embodiments of the invention described herein. Such equivalents are intended to be encompassed by the following claims.

1. A device, comprising: (a) a control means; (b) an alarm, which is connected to the control means and can transmit an audible signal to a driver; (c) a vehicle speed detector, which is connected to the control means; (d) a steering wheel cover, further comprising a plurality of sensor means, which are connected in parallel to the control means and can detect the presence or absence of a driver's hand; and (e) a timer, which is triggered when a driver's hand is removed from the steering wheel cover, wherein the alarm can only be activated when the automobile is traveling above a pre-determined speed and at least one hand of the driver has not been in contact with the steering wheel cover for a pre-determined period of time as determined by the timer.

2. The device of claim 1, wherein the steering wheel cover additionally comprises a lighting device.

3. The device of claim 1, further comprising one or more conductive gloves for covering one or more hands of a driver, wherein said gloves have an electrical conductivity similar to the electrical conductivity of a drivers hands.

4. The device of claim 1, wherein the vehicle speed detector is a wireless device.

5. The device of claim 4, wherein the wireless device is a Global Positioning System (GPS).

6. The device of claim 1, further comprising: a driver identification device.

7. The device of claim 6, wherein the driver identification device is a key pad for input of a password.

8. The device of claim 1, further comprising a data recording and output device for keeping a record of alarm activations.

9. The device of claim 8, wherein the data recording and output device keeps a record of a parameter selected from the group consisting of: the driver's identification, the internal alarm, repeated internal alarms and external alarms or vehicle speed and road conditions.

10. The device of claim 1, further comprising an external vehicle alarm for indicating an unsafe driving condition outside of the vehicle.

11. The device of claim 10, wherein the external vehicle alarm is only activated when one group of steering wheel sensors senses the presence of a hand for a predetermined period of time at or above a predetermined speed.

12. The device of claim 1, further comprising one or more active steering wheel sensor group indicators to inform the driver of the position of the hands on the steering wheel that will avoid activation of the alarms or alarm recording.

13. The device of claim 1, further comprising a road condition detector

14. The device of claim 13, wherein the road condition detector is a wireless device.

15. The device of claim 1, further comprising a hand comfort device for providing comfort to the driver

16. The device of claim 15, wherein the hand comfort device is a hand warmer or a vibrator.

17. The device of claim 1, further comprising a cruise control cluster of driver inputs and indicators.

18. The device of claim 1, further comprising a clock positioned for ease of driver observation.
